(19) United States
(12) Patent Application Publication
(10) Pub. No.: US 2003/0234533 A1
(43) Pub. Date: Dec. 25, 2003

(54) Postage stamp covered with hologram

(76) Inventor: Stanley D.C. Kim, Hon, HI (US)

Correspondence Address: Eugene OAK, Ph. D., J.D.,, 610 S. Van Ness Ave., Los Angeles, CA, 90005, US

(21) Appl. No.: 10/176,788

(22) Filed: Jun. 24, 2002

(51) Int. Cl. G09F 3/00

(52) U.S. Cl. 283/71

(57) ABSTRACT

A novel postage stamp is covered with a partially transparent holographic film containing, including but not limited to, a logo, drawing and phrase, on the face of the postage stamp. The partially transparent holographic film is manufactured separately and supplied. The size of the film meets the size of the postage stamp over which the film covers. The partially transparent film is a multi-layer film consisted of; 1) a heat adhesive layer consisting of homo- and co-polymers of EVA (poly ethylene vinyl acetate), EAA (poly acetyl acetate), ionomer and VLDPE (very low density poly ethylene); 2) a hologram layer containing, including but not limited to, a logo, drawing and phrase and messages; 3) a surface protecting layer consisting of a printable material, including but not limited to, homo- and co-polymers of flexible PVC (poly vinyl chloride), PMMA (poly methyl methacrylate); and PC (poly carbonate). The film is coextruded with the postage stamp to be adhered on the face of the stamp. The film protects the postage stamp from the rain, snow and humidity. The image of the hologram changes from the original drawing of the postage stamp to an advertising sticker depending on the angle of the view. The image of the holograms prevents forgery of the postage stamp.

The present invention relates to a novel postage stamp covered with a partially transparent holographic film on the face of the postage stamp.

### BACKGROUND OF THE INVENTION

During the delivery of a mail, rain and snow wets the postage stamp and falls apart from the mail envelopes. Plastic film can protect the postage from the moistures. Forgery of the postage stamp can be prevented by the holograms on the postage stamp. Cost elevation for the film can be supported by the advertising rate, which can be compensated well over the extra cost. Profits from the advertisement can be credited to the Post Office and to the subscribes of the postage.

1. Field of the Invention

This invention relates to a novel postage stamp covered with a partially transparent film containing hologram. The hologram-imaged film protects the postage stamp from moisture during handling and prevents forgery of the postage stamp.

2. Description of the Prior Art

U.S. Pat. Nos. D 328,572 and D 318,605 to Dudley and U.S. Pat. No. D 327,370 to Mittelstrass illustrate frame for postage stamp to use a postage stamp for a decorative items. U.S. Pat. No. 6,203,067 to Shipston, et al. and U.S. Pat. No. 6,004,630 to Sanchez, et al. teach to coat liner less postage stamps with a paper substrate on the bottom surface with pressure sensitive adhesive. U.S. Pat. No. 5,902,439 to Pike, et al. illustrates a peel able backing sheet. The prior arts are to prevent sticking of the postage stamps to the pressure sensitive adhesives. U.S. Pat. No. 5,685,570 to Gray, et al. discloses a partially luminescent-coated stamp. The coating is applied as a grid to permit detection by a postage stamp luminescence detector. The non-coated regions permit penetration and drying of a stamp canceling ink.

U.S. Pat. No. 6,266,166 to Katsumata et al. and U.S. Pat. No. 6,291,109 to Suga et al. illustrate mass developing methods of hologram on a thin film.

However, none of the prior arts illustrates hologram coated partially transparent postage stamp.

### SUMMARY OF THE INVENTION

It is the purpose of this invention to provide a novel postage stamp covered with a partially transparent holographic film containing, including but not limited to, a logo, drawing and phrase, on the face of the postage stamp. The partially transparent holographic film is manufactured separately and supplied. The size of the film fits the size of the postage stamp over which the film covers. The partially transparent film is multi-layer film consisted of; 1) heat adhesive layer being made of homo- and co-polymer of EVA (poly ethylene vinyl acetate), EAA (poly acetyl acetate), ionomer and VLDPE (very low density poly ethylene); 2) hologram layer containing, including but not limited to, a logo, drawing and phrase and messages of broadcasting; 3) surface protecting layer of printable material such as homo- and co-polymers of a flexible PVC (poly vinyl chloride), PMMA (poly methyl methacrylate) and PC (poly carbonate) for a stamp canceling ink. The film is coextruded with the postage stamp to be adhered on the face of the stamp. The film protects the postage stamp from the rain, snow and humidity during handling. The image of the hologram changes from the original drawing of the postage stamp to an advertising sticker depending on the degree of view. The image of the holograms prevents forgery of the postage stamp.

### BRIEF DESCRIPTION OF FIGURES

FIG. 1 is a schematic diagram of a postage stamp covered with a partially transparent holographic film of this invention.

FIG. 2 is a schematic drawing of postage stamp facial images, which is changing depends on the view angle.

FIG. 3 is a cross sectional view of the partially transparent film layer of this invention mounted on a postage stamp.

FIG. 4 is a schematic drawing of hot melt adhering process of a postage stamp and partially transparent holographic film of this invention.

FIG. 5 is a schematic drawing of a booklet of postage stamps covered with partially transparent holographic film of various designs.

### DETAILED DESCRIPTION OF THE PREFERRED EMBODIMENTS

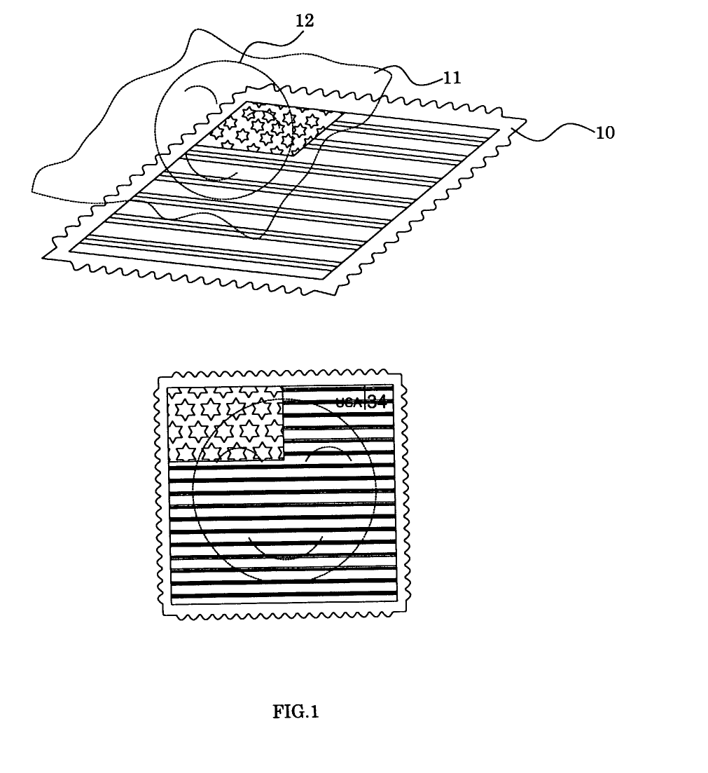

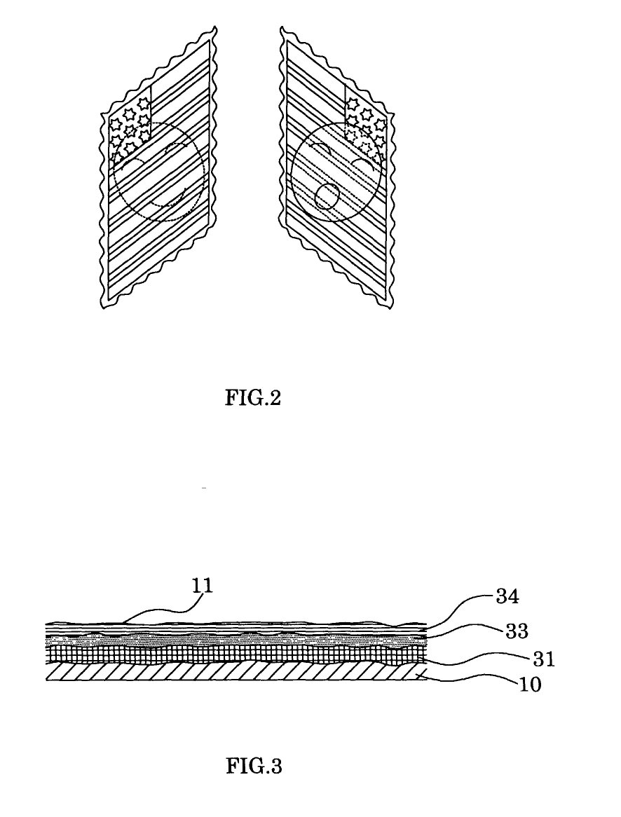

FIG. 1 is a schematic diagram of a postage stamp covered with a partially transparent holographic film of this invention. A postage stamp (10) is covered with partially transparent film (11) containing hologram (12). When the film (11) is tightly sealed on the face of a postage stamp (10). When look at the stamp in front, the hologram (12) does not appear on the face of the stamp. However, the facial images of postage stamp is changing depends on the view angle as shown in FIG. 2. The size of the hologram is smaller than the face of the postage stamp.

FIG. 3 is a cross sectional view of the partially transparent film layer of this invention mounted on a postage stamp. The partially transparent hologram containing film (11) is composed of three layers. 1) The adhesive layer (31) consists of, including but not limited to, homo- and co-polymers of EVA (poly ethylene vinyl acetate), EAA (poly acetyl acetate), ionomers, LDPE (Low Density Poly Ethylene), VLDPE (very low density poly ethylene) and M-LLDPE (Metallocene catalyzed Linear Low Density Poly Ethylene), which have low melt temperature, good heat sealability, low haze and good transparency. The adhesive layer (31) is adhered to the face of a postage stamp (10). The other side of the adhesive layer is facing the hologram containing film (33). The adhesive layer (31) has thickness less than 2 μm, haze less than 2% and heat seal strength greater than 3N/15 mm at 85° C. 2) The partially transparent hologram containing film (33) is made by typical methods described in prior arts and is out of the scope of this invention. 3) The surface-protecting layer (34) is made of, including but not limited to, homo polymers and copolymers of flexible PVC (Poly Vinyl Chloride), PMMA (Poly Methyl Methachrylate) and PC (Poly Carbonate). Such polar polymers can hold the erasing stamp ink during normal handling of the stamp.

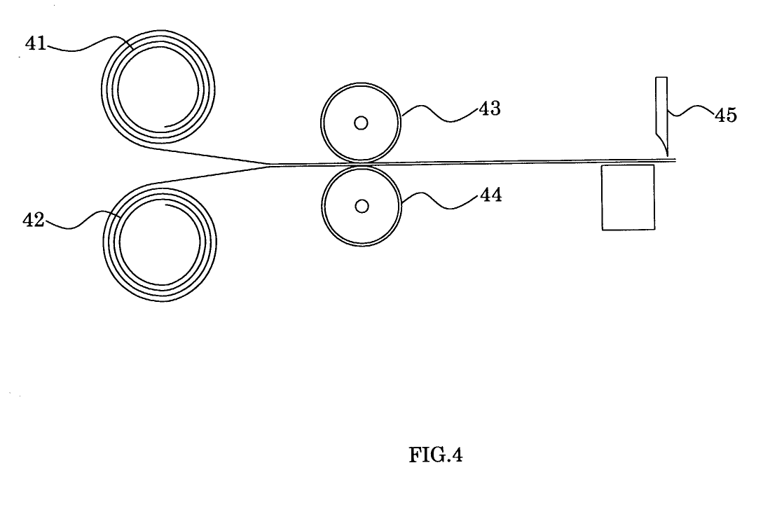

FIG. 4 is a schematic drawing of hot melt adhering process of a postage stamp and partially transparent holographic film of this invention. A roll of the partially transparent film (41) of this invention and a roll of postage stamps (42) are fed to the heating rollers (43) and (44). Surface temperatures of the rollers are controlled between 85 to 90° C. for good adhesion without damaging the hologram and the postage stamp. The stamps with hologram are cut into desired size by a cutter (45).

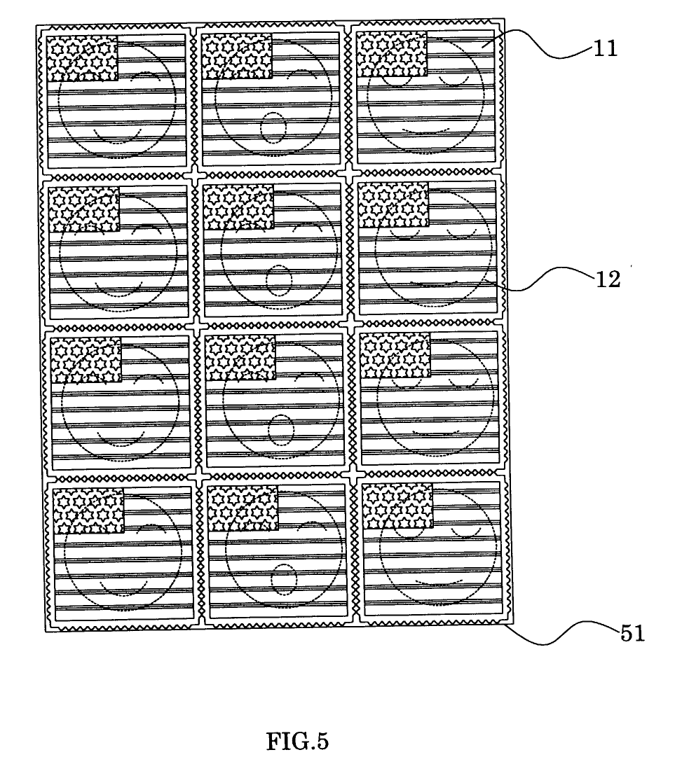

FIG. 5 is a schematic drawing of a booklet of postage stamps covered with partially transparent holographic film of various designs. The transparent film (11) has various hologram designs (12), which locates on the face of post stamp at different position on stamp booklet (51).

The best mode of this invention is to use m-LLDPE for the heat adhesive layer (31) and flexible PVC for the cover layer (34). The thickness of each layer is less than 1 μm. The surface temperature of the heating roller (43) and (44) is in the range of 85 to 87° C.

It is clear that the technology and the idea of introducing advertising desigs on a negotiable instrument for cost saving can be applied to others such as checks, paper money, stocks with small variations.

What is claimed is:

1. A postage stamp covered with a partially transparent holographic designed film consists of a heat adhesive layer, hologram containing film layer and surface protecting layer.

2. The size of the holographic design in the film, in claim 1, fits the size of the face of a postage stamp over which the film covers.

3. The heat adhesive layer, in claim 1, is made of homo- and co-polymers of EVA(poly ethylene vinyl acetate), EAA (poly acetyl acetate), ionomer, VLDPE(very low density poly ethylene), LDPE (Low Density Poly Ethylene), M-LLDPE(Metallocene Catalyzed Linearized Low Density Poly Ethylene).

4. The heat adhesive layer, in claim 1, is made of M-LLDPE.

5. The thickness of the heat adhesive layer, in claim 1, is in the range of 0.01 to 10 μm.

6. The adhesive layer, in claim 1, has haze less than 2%.

7. The adhesive layer, in claim 1, has heat seal strength greater than 3N/15 mm at 85° C.

8. The thickness of the heat adhesive layer, in claim 1, is in the range of 0.1 to 2 μm.

9. The designs of the hologram layer, in claim 1, contains a logo, drawings, phrase and messages.

10. The designs of the hologram layer, in claim 1, contain an advertising logo, phrase, message and trade marks.

11. The surface protecting layer, in claim 1, is made of homo- and co-polymers of flexible PVC, PMMA and PC.

12. The surface-protecting layer, in claim 1, is made of flexible PVC.

13. The thickness of the surface protecting layer, in claim 1, is in the range of 0.01 to 10 μm.

14. The thickness of the surface protecting layer, in claim 1, is in the range of 0.1 to 1 μm.

15. The partially transparent holographic designed film, in claim 1, is coextruded with the postage stamp through heated roller within the surface temperature range of 80° C. to 120° C.

16. The partially transparent holographic designed film, in claim 1, is coextruded with the postage stamp through heated roller within the surface temperature range of 85° C. to 87° C.
